(19) United States
(12) Patent Application Publication
(10) Pub. No.: US 2007/0033014 A1
(43) Pub. Date: Feb. 8, 2007

(54) Encoding of transient audio signal components

(75) Inventors: Andreas Johannes Gerrits, Eindhoven (NL); Albertus Cornelis Den Brinker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/570,438

(22) PCT Filed: Aug. 26, 2004
(86) PCT No.: PCT/IB04/51572

§ 371 Date: Mar. 2, 2006

(30) Foreign Application Priority Data
Sep. 9, 2003 (EP) 03103325.1

(51) Int. Cl. G10L 19/00

(52) U.S. Cl. 704/219

(57) ABSTRACT

A method of encoding (1) an audio signal (x(t) is disclosed. The position of a transient signal component of the audio signal is estimated (110). A first portion (ti) of the transient signal component is modeled (111) with a first plurality of sinusoidal components. A difference (d) between the first portion (ti) of the transient signal component and the transient signal component is estimated. The difference is modeled with a measure (E) of the energy of the difference; and the measure (E) is included in an audio stream (AS).

The present invention relates to coding and decoding audio signals.

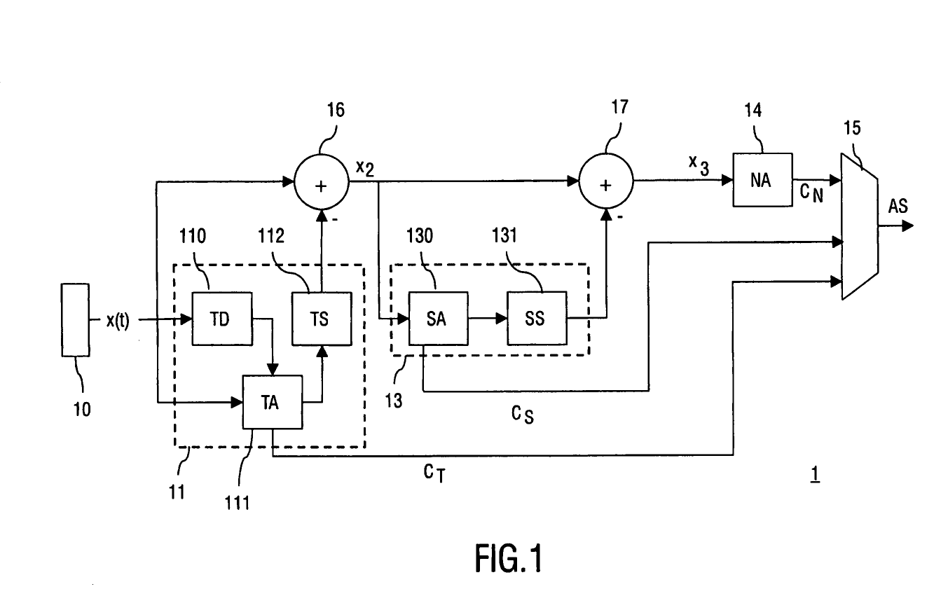

Referring now to FIG. 1, a parametric coding scheme in particular a sinusoidal coder is described in US Published Application No. 2001/0032087A1. In this coder (1), an input audio signal x(t) supplied from a channel 10 is split into several (overlapping) segments or frames, typically of length 20 ms. In general, each segment is decomposed into transient (C_{T}), sinusoidal (C_{S}) and noise (C_{N}) components by successive coding stages 11, 13 and 14. (It is also possible to derive other components of the input audio signal such as harmonic complexes although these are not relevant for the purposes of the present invention.)

The first stage of the coder comprises a transient coder 11 including a transient detector (TD) 110, a transient analyzer (TA) 111 and a transient synthesizer (TS) 112. The detector 110 estimates if there is a transient signal component and its position. This information is fed to the transient analyzer 111. If the position of a transient signal component is determined, the transient analyzer 111 tries to extract (the main part of) the transient signal component. It matches a shape function to a signal segment preferably starting at an estimated start position, and determines content underneath the shape function, by employing for example a (small) number of sinusoidal components. This information is contained in the transient code C_{T}.

The transient code C_{T} is furnished to the transient synthesizer 112. The synthesized transient signal component is subtracted from the input signal x(t) in subtractor 16, resulting in a signal x₂.

The signal x₂ is furnished to a sinusoidal coder 13 where it is analyzed in a sinusoidal analyzer (SA) 130, which determines the (deterministic) sinusoidal components. The end result of sinusoidal coding is a sinusoidal code C_{S} and a more detailed example illustrating the conventional generation of an exemplary sinusoidal code C_{S} is provided in PCT patent application No. WO00/79519A1.

From the sinusoidal code C_{S} generated with the sinusoidal coder, the sinusoidal signal component is reconstructed by a sinusoidal synthesizer (SS) 131. This signal is subtracted in subtractor 17 from the input x₂ to the sinusoidal coder 13, resulting in a remaining signal x₃ devoid of (large) transient signal components and (main) deterministic sinusoidal components.

The remaining signal x₃ is assumed to mainly comprise noise and a noise analyzer 14 produces the noise code C_{N} representative of this noise, as described in, for example, PCT patent application No. WO01/89086A1.

In a multiplexer 15, an audio stream AS is constituted which includes the codes C_{T}, C_{S} and C_{N}.

In the transient coder 11, a part of the audio signal is labeled as a transient if an event occurs that is localized in time, for example, attacks of castanets or high-hats.

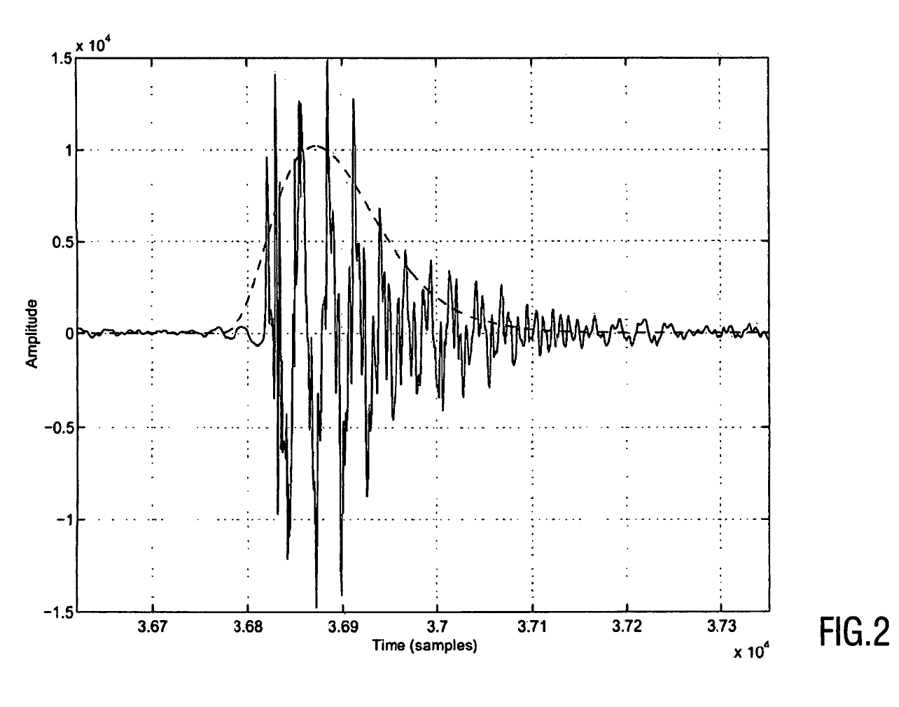

In US Published Application No. 2001/0032087A1, a transient is modeled with a number of sinusoids that are windowed by a special transient window (i.e. a Meixner window). In FIG. 2, an estimated Meixner window (dashed line) for an audio signal (solid line) is shown. The transient estimation procedure comprises three steps:

transient position estimation: The position of the transient in the audio signal is determined by a transient detector 110;

transient envelope estimation: In case of a Meixner transient, the Meixner window, describing the time envelope of the transient, is estimated by a transient analyzer 111;

sinusoidal content estimation: Using the estimated Meixner window, the analyzer 111 estimates a number of sinusoids to describe the transient. The sinusoids are represented by a frequency and three complex, polynomial amplitudes.

In an implementation, where 7 sinusoids used for a Meixner transient, the bit rate range required by the transient module is typically between 0.5 and 2.0 kbit/s, depending on the number of transients that are detected in the audio signal.

By using the transient modeling as described above, a fair audio quality for excerpts containing transients is obtained. However, the audio quality can be improved by increasing the number of sinusoids that are used to model the transient. In this case, the attack of a transient is better defined and more “presence” of the transient is obtained. It has been found, for example, that good results are obtained by increasing the number of sinusoids from 7 to 25.

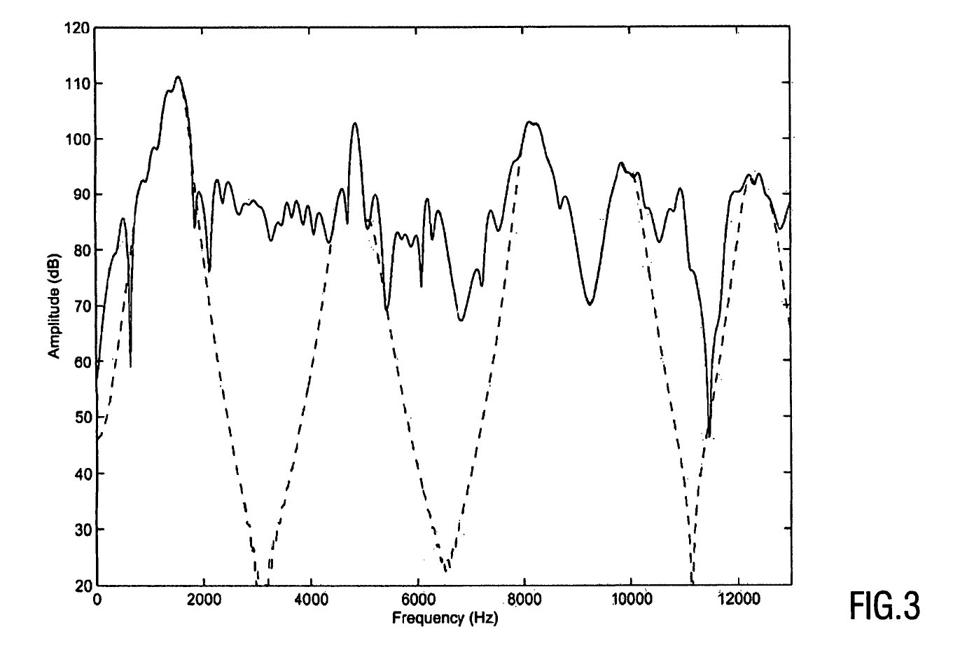

Referring to FIG. 3, the spectrum of a transient modeled by 7 (dashed lines) and 25 (solid line) sinusoids respectively is shown. The spectrum of a transient modeled by 25 sinusoids resembles the spectrum of the original transient whereas the transient that is modeled by 7 sinusoids has some clear holes in the spectrum, even though the 7 sinusoids do model the important peaks in the spectrum.

However, using 25 sinusoids, the bit rate is required by the transient module 11 is increased significantly to around 6 kbit/s (from 2 kbit/s using 7 sinusoids). This increase in bit rate for the transient part has to be saved in the sinusoidal and/or noise modeling components 13, 14 of the coder, thus reducing the overall audio quality.

According to the present invention there is provided a method according to claim 1.

The invention extends the current transient model by including parameters for a noise component in the description of a transient. Thus, instead of using only sinusoids, both sinusoids and noise are used to describe the transient.

In preferred embodiments, the time interval of the transient modeled by the sinusoids and noise can differ.

The parameters for the noise component of a transient result in a small increase in bit rate. However, the perceptual quality of the transients is improved.

The invention thus reduces the bit rate otherwise required by additional sinusoids, while maintaining audio quality. This is because the additional sinusoids do not model clear peaks in the spectrum, as do the initial sinusoids, rather the additional sinusoids more or less fill the gaps between the initial sinusoids. In the time domain, the signal described by the additional sinusoids is noise-like and so these portions of the spectrum have been found to be more effectively modeled with noise parameters.

An embodiment of the invention will now be described, by way of example, with reference to the accompanying drawings, in which:

FIG. 1 is a block diagram of an audio coder;

FIG. 2 shows an example of a transient envelope (dashed line) for a Castanets excerpt (solid line);

FIG. 3 shows an example of a spectrum of a transient modeled by 7 (dashed line) and 25 (solid line) sinusoids respectively;

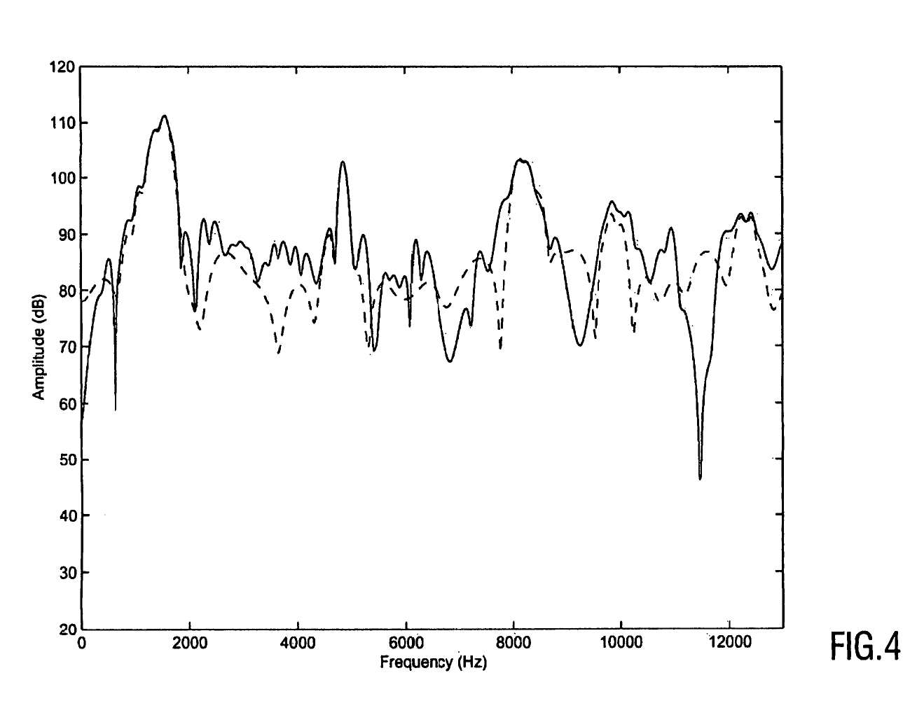

FIG. 4 shows an example of a spectrum of a transient extended with noise according to a preferred embodiment of the invention (dashed line) compared to a spectrum of a transient modeled by 25 sinusoids (solid line);

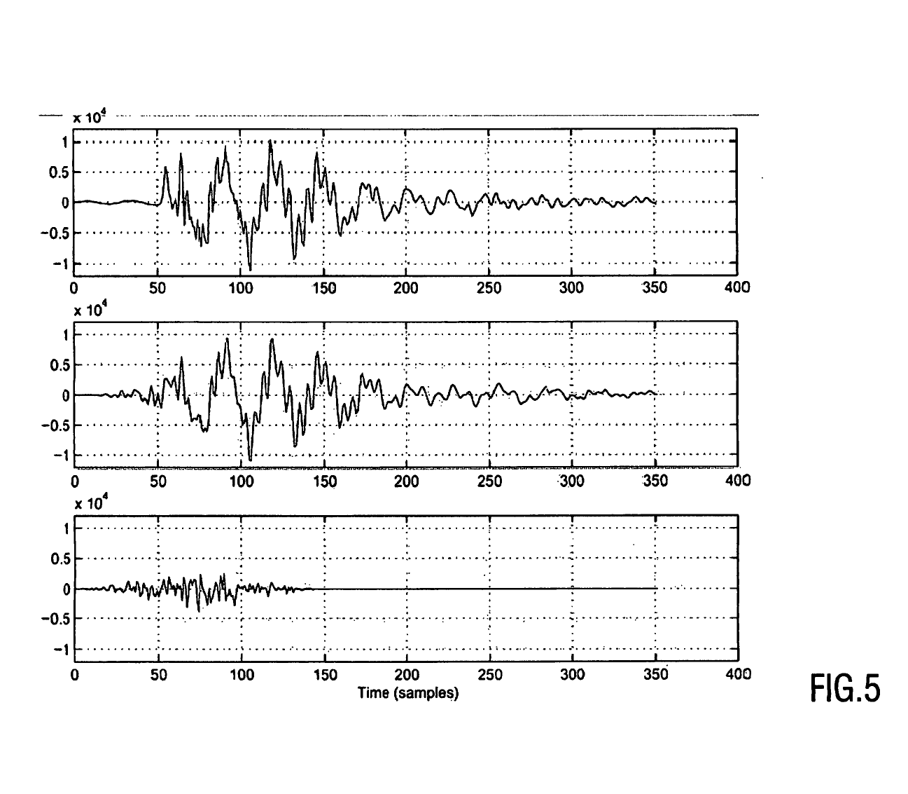

FIG. 5 shows the components of a transient modeled according to the preferred embodiment of the invention;

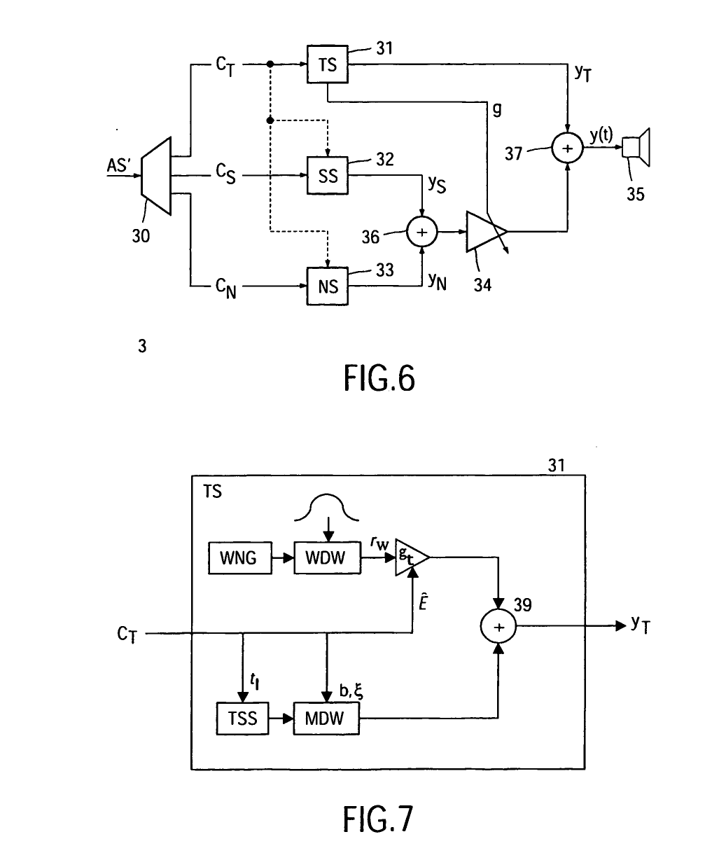

FIG. 6 is a block diagram of an audio decoder; and

FIG. 7 is a more detailed diagram of a transient synthesizer according to a preferred embodiment of the invention.

According to a preferred embodiment of the present invention the additional (18) sinusoids mentioned above are instead modeled by a localized noise burst with the same energy as the additional sinusoids. The noise burst is placed at the start of the transient and a fixed time window is used to shape the noise burst. Only the energy of the noise burst has to be transmitted within the transient codes (C_{T}) of an encoded signal (AS), and so the bit rate requirement to implement the embodiment is only increased slightly. FIG. 4 shows the spectrum of the transient where a noise burst has been added to a spectrum modeled by 7 sinusoids (dashed lines). It can be seen that the spectrum is comparable to the spectrum of the transient that is modeled by 25 sinusoids (solid line).

More specifically, in the encoder of the preferred embodiment, the transient analyzer 111, estimates the Meixner transient and models the transient using a high number of sinusoids (e.g. 25) in a conventional manner. This signal is denoted by tₕ and has length U=720 samples (at 44.1 kHz sampling rate). The most relevant sinusoids (for example 7) are used to generate another transient signal, tₗ. Selection of the most relevant sinusoids can employ for example an energy based cost function or any other conventional criterion. In any case, the signal tₗ is then subtracted from the signal tₕ to provide a difference signal d=tₕ-t₁ which is used to generate the noise burst. The noise burst is placed at the start of the transient and has length L, preferably shorter than the transient. In the preferred embodiment, L=150 samples (at 44.1 kHz sampling rate). The difference signal is windowed according to the function:
d_{w}(n)=d(n)wₒ(n), for n=1, . . . , L,
where wₒ is a window, with a fade-out slope, which is defined as:

$${w}_{o} ( n ) = \{ \begin{matrix}1 , & for n = 1 , … , L / 2 \\ 0.5 ( 1 + cos ( 2 π ( n - L / 2 ) / L ) ) , & for n = L / 2 + 1 , … L\end{matrix}$$

The fade-out is the second part of a Hanning window. However, different definitions for the window are possible.

The energy of the windowed segment d_{w} is measured as follows:

$$E = 1 / L {\sum }_{n = 1}^{L} {{d}_{w} ( n )}^{2}$$

and the energy E along with the parameters for the sinusoids comprising signal tₗ are quantized and transmitted to the decoder as part of the transient codes C_{T}. Thus, the information relating to the (additional) sinusoids of the difference signal d is discarded and replaced by the noise burst parameter.

The signal tₕ is synthesized by synthesizer 112 as in the conventional encoder and is subtracted (16) from the input signal x(t) in order to create a residual signal x₂ that is fed in the sinusoidal analysis module 13 as before. Alternatively, the transient codes C_{T} could be synthesized by synthesizer 112 as in the decoder (explained below) before being subtracted from the input signal x(t) to produce residual signal x₂.

In this way, the transient part can be better modeled by the sinusoidal 13 and noise 14 modules of the audio coder.

Referring now to FIG. 6, a decoder according to a preferred embodiment of the invention is generally of the same form as the decoder of US Published Application No. 2001/0032087A1. Here, an audio stream AS′, e.g. generated by an encoder according to FIG. 1, is obtained from a channel such as a data bus, antenna system, storage medium etc. The audio stream AS is de-multiplexed in a de-multiplexer 30 to obtain the codes C_{T}, C_{S} and C_{N}. These codes are furnished to a transient synthesizer 31, a sinusoidal synthesizer 32 and a noise synthesizer 33 respectively.

In the preferred embodiment of the present invention, in the transient synthesizer 31, the parameters for the signal tₗ comprising the initial sinusoids are used to re-construct the sinusoids in synthesizer TSS, FIG. 7. This signal is then windowed (MDW) according to the Meixner function parameters b, ξ in a conventional manner.

At the same time, the encoded energy value is reconstructed, resulting in energy Ê. A white noise generator (WNG) provides a segment of high-pass filter noise with length L. Preferably, the high-pass filter has a cut-off frequency of 300 Hz in order to avoid the modeling of very low frequencies by noise. The filtered noise signal is windowed (WDW) using window w, which is preferably a Hanning window of length L. However, other windows are also possible (e.g. an asymmetric Hanning window).

The windowed noise signal is denoted by r_{w}. This signal is scaled by gain gₜ, which is calculated according to:

$${g}_{t} = \sqrt{\frac{\hat{E}}{1 / L {\sum }_{n = 1}^{L} {{r}_{w} ( n )}^{2}}}$$

The resultant generated energy burst is added to the synthesized sinusoidal components of the transient in adder 39 thus completing the synthesis of the transient signal y_{T} which can be treated as before when being added to the other synthesized components of the signal y(t).

In FIG. 5 the sinusoidal and noise components for a modeled transient are shown. The upper trace shows the time signal of the transient. The second trace shows the modeled sinusoidal component of the transient and the bottom trace shows the noise burst placed at the start of the transient. It will be seen that most of the transient is described by the sinusoidal component, however, in the important attack of the transient, the noise component is added.

Referring back to FIG. 6, the sinusoidal code C_{S} is used to generate signal y_{S}, described as a sum of sinusoids on a given segment. At the same time, the noise code C_{N} is fed to a noise synthesizer NS 33, which is mainly a filter, having a frequency response approximating the spectrum of the noise. The NS 33 generates reconstructed noise y_{N} by filtering a white noise signal with the noise code C_{N}.

The total signal y(t) comprises the sum of the transient signal y_{T} and the product of any amplitude decompression (g) and the sum of the sinusoidal signal y_{S} and the noise signal y_{N}. The audio player comprises two adders 36 and 37 to sum respective signals. The total signal is furnished to an output unit 35, which is e.g. a speaker.

This invention can be used in an audio coder where transients are described by windowed sinusoids.

1. A method of encoding (1) an audio signal (x(t) comprising the steps of:
estimating (110) a position of a transient signal component of the audio signal;
modeling (111) a first portion (tₗ) of said transient signal component with a first plurality of sinusoidal components;
estimating a difference (d) between the first portion (tₗ) of the transient signal component and the transient signal component;
modeling (111) said difference with a measure (E) of the energy of said difference; and
including said measure (E) in an audio stream (AS).

2. A method as claimed in claim 1 wherein the step of modeling said first portion comprises:
modeling said transient signal component with a second plurality of sinusoidal components (tₕ); and
selecting from said second plurality of sinusoidal components said first plurality of sinusoidal components according to a criterion.

3. A method as claimed in claim 2 wherein said criterion relates to the energy of the sinusoidal components.

4. A method as claimed in claim 2 wherein said estimating step further comprises subtracting a transient modeled with said first plurality of sinusoidal components from a transient modeled with said second plurality of sinusoidal components to provide said difference (d).

5. A method as claimed in claim 4 wherein said estimating step further comprises windowing said difference in the time domain to fade out said difference.

6. A method as claimed in claim 5 wherein said window is shorter in time than said transient signal component.

7. A method as claimed in claim 5 wherein said step of modeling said difference comprises determining an energy of said windowed difference (d(w)).

8. A method of decoding an audio stream (AS) comprising:
reading an encoded audio stream (AS′) including one or more transient codes (C_{T}), each comprising a first plurality of sinusoidal components and an energy measure (E);
synthesizing (TSS) a first portion of a transient signal component with said first plurality of sinusoidal components;
synthesizing (WNG) noise for a time period of said transient signal component;
modifying (g) said synthesized noise according to said energy measure (E); and
adding said synthesized first portion and said modified noise to generate a synthesized transient component (y_{T}) of an audio signal (y(t)).

9. A method as claimed in claim 8 further comprising the step of high pass filtering said synthesized noise.

10. A method as claimed in claim 8 further comprising the step of windowing (WDW) said synthesized noise to fade out said noise over said time period.

11. A method as claimed in claim 8 wherein said modifying step comprises scaling (g) said synthesized noise by said energy measure.

12. Audio stream (AS) comprising one or more transient codes (C_{T}) each comprising a first plurality of sinusoidal components representing a first portion of a transient component (tₗ) of an audio signal and an energy measure (E) representing a difference (d) between the first portion (tₗ) of the transient signal component and the respective transient signal component.

13. Audio coder (1) comprising:
an analyzer (110) for estimating a position of a transient signal component of the audio signal;
a first modeling component (111) for modeling a first portion (tₗ) of said transient signal component with a first plurality of sinusoidal components;
means for estimating a difference (d) between the first portion (tₗ) of the transient signal component and the transient signal component;
a second modeling component (111) for modeling said difference with a measure (E) of the energy of said difference; and
a bitstream generator arranged to include said measure (E) in an audio stream (AS).

14. Audio player (3) comprising:
means for reading an encoded audio stream (AS′) including one or more transient codes (C_{T}), each comprising a first plurality of sinusoidal components and an energy measure (E);
a synthesizer (TSS) for synthesizing a first portion of a transient signal component with said first plurality of sinusoidal components;
a synthesizer (WNG) for synthesizing noise for a time period of said transient signal component;
means for modifying (g) said synthesized noise according to said energy measure (E); and
an adder for adding said synthesized first portion and said modified noise to generate a synthesized transient component (y_{T}) of an audio signal (y(t)).

15. An audio system comprising an audio coder according to claim 13 and an audio player according to claim 14.
